(19) United States
(12) Patent Application Publication
(10) Pub. No.: US 2005/0114733 A1
(43) Pub. Date: May 26, 2005

(54) Concurrent I/O

(76) Inventors: Chimsong Sul, Mountain View, CA (US); Fidel Muradali, Mountain View, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/721,606

(22) Filed: Nov. 25, 2003

(51) Int. Cl. G06F 11/00

(52) U.S. Cl. 714/30

(57) ABSTRACT

A DUT has a multiple scan paths, at least one per I/O pin. That is, instead of one scan path for every two pins there is one scan path for every pin, thus effectively doubling the number of scan paths inside of a DUT.

### BACKGROUND

Scan Path Testing—Referring to FIG. 1, it is common to test errors on a chip using a scan path technology. Typically, there are a number of scan paths 9 within a device under test (DUT) 1, each scan path 9 receiving input data 8 via an input pin 2 and producing output data 10 via output logic 11 to an output pin 12. A tester (not shown) typically shifts data into the scan path 9 serially through the input pin 2. The chip 1 is clocked and performs some kind of processing on the data, and then the processed data is shifted back out through the output pin 12 and analyzed. Generally, the scan path technique is that data on internal nodes can be latched and shifted out to make sure that those nodes have the expected data based upon the input data. Therefore, scan path testing is effectively an internal probing of the DUT 1.

One problem with conventional scan path testing is that two pins are needed for each scan path 9, one chip input pin 2 and one chip output pin 12. Therefore, the number of pins on the DUT 1 limits the possible number of scan paths 9.

Referring again to FIG. 1, another problem is the need for the multiplexer 7 on the output side of the scan path 9. The multiplexer 7 selects between scan output data 10 during scan test and functional output data 6 from a functional circuit 5 during normal operation. The multiplexer 7 introduces a delay that may cause a problem or limit performance during the normal mode operation.

Functional Test—Referring again to FIG. 1, a functional test is an actual functioning of the circuit 5 under test conditions. A tester (not shown) provides data to the circuit 5 via input pin 2, input logic 3, and the functional input 4. The circuit 5 processes the data and passes the processed data to the functional output 6, the output logic 11, and to the output pin 12. The tester (not shown) then analyzes the data.

Compaction—Referring to FIG. 2, in semiconductor testing “compaction” is a technique used to reduce the number of output bits that need to be analyzed during a test function. The compactor 209 consists of a number of serially connected cyclic shift register cells CSRC that form a cyclic shift register 212. Typically, scan input data signals SID are shifted into a number of scan chains 210 and then the scan output data signals SOD from these scan chains are gated with compactor feedback data signals CFD from the cyclic shift register cells CSRC. Each cyclic shift register cell CSRC receives gated input from an XOR gate 211. When all the scan output data has been shifted through the cyclic shift register 212, the value retained in the cyclic shift register has a known value which can be shifted out and analyzed as a compacted output data signal COD. For example, one can shift in 1000 bits through the cyclic shift register 212 that may only have 20 cyclic shift register cells CSRC. Therefore, instead of having to analyze and compare all 1000 bits to a known bit pattern, one only need compare the final 20 bits from the compaction cyclic shift register 212 to the known bit pattern.

Referring again to FIG. 2, although not a problem per se with compaction, much of the data that is input to the compaction cyclic shift register 212 is of a don't care nature. That is, some of the compacted output data COD is non-deterministic meaning that one cannot predict its value based on the value of the scan output data signal SOD. Therefore, in order to allow compaction to work, i.e., so that an unknown value doesn't give an unknown result, the don't care data values need to be masked. Referring to FIG. 3, this is done with logic for each individual cell 17 of the cyclic shift register 212 (FIG. 2) that is adjacent to and part of the same circuit as the cyclic shift register. The mask signal 13 and the scan output data SOD are gated with an AND gate 15 before being input to the individual cell 17. By changing the value of the mask signal 13, one can mask the scan output data SOD for a given clock cycle. Consequently, the output 18 of the individual cell 17, is no longer of a don't care nature.

Reseeding—Referring to FIG. 4, another known concept is called reseeding, which is used to initialize built-in self-test (BIST). Basically, one uses circuitry on a chip to generate test data from an initial seed value. For example, an initial seed value 21 is input to a multiplexer 22 whose output is the scan input data 23. This scan input data 23 is then fed back to the multiplexer 22 via a second multiplexer 25 and a flip-flop 20. This particular example basically recycles the same scan input. However, a linear feedback shift register's (LFSR) (not shown) output 27 and scan output data 28 can be fed back via an exclusive-or gate 29 into the second multiplexer 25 and the flip-flop 20 to provide a more complex self-generation test.

### SUMMARY

A DUT has a multiple scan paths, at least one per I/O pin. That is, instead of one scan path for every two pins there is one scan path for every pin, thus effectively at least doubling the number of scan paths inside of a DUT.

### BRIEF DESCRIPTION OF THE DRAWINGS

FIG. 1 is a block diagram of a conventional scan test and functional integrated circuit.

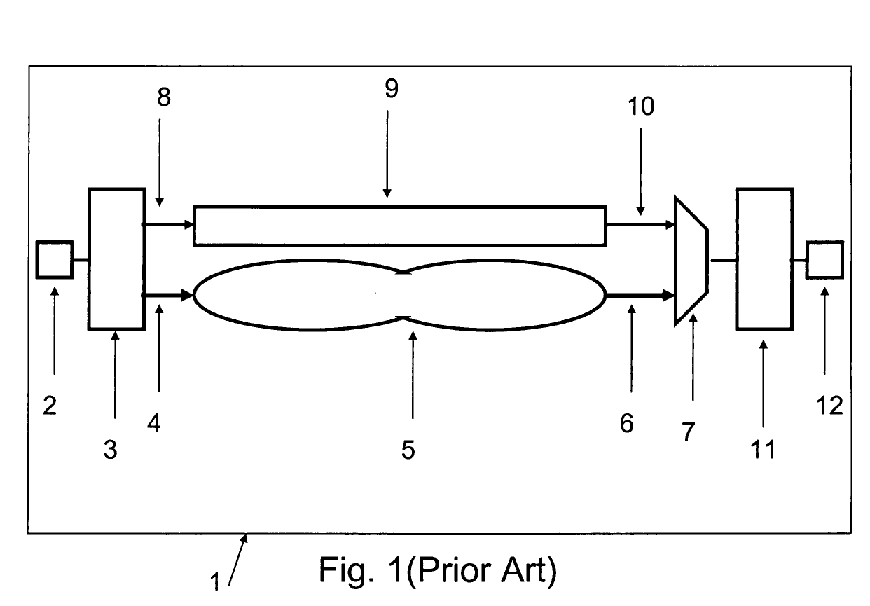

FIG. 2 is a block diagram of a conventional compactor.

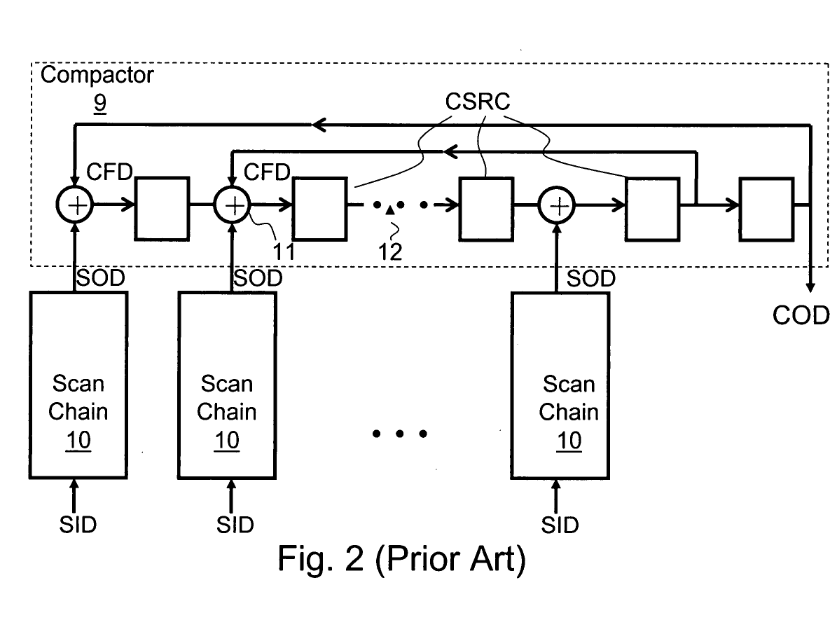

FIG. 3 is a logic diagram of components used in a conventional compaction test to eliminate don't care values.

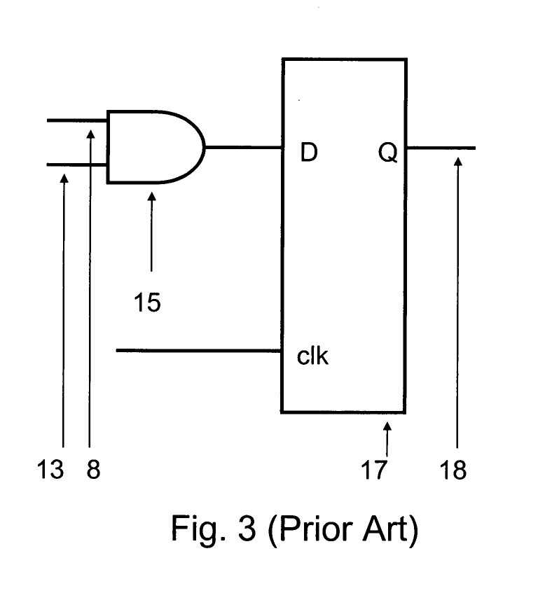

FIG. 4 is a logic diagram of components used in a conventional reseeding BIST scheme.

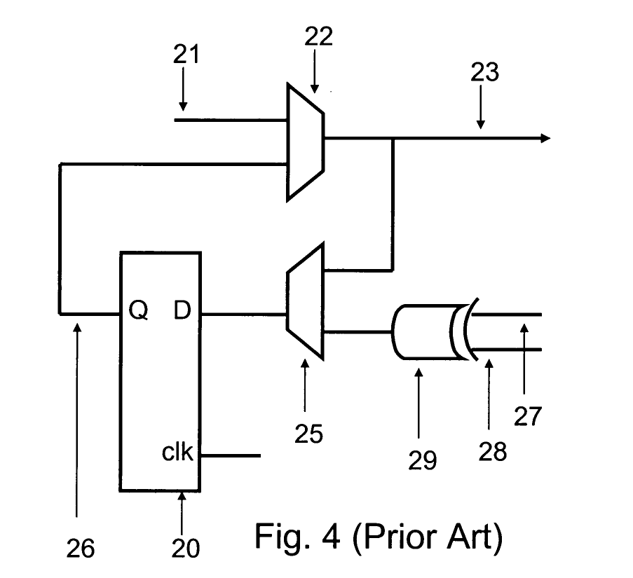

FIG. 5 is a block diagram of a scan integrated circuit requiring only a single I/O pin according to an embodiment of the invention.

FIG. 6 is a block diagram of different scan test configurations each effectively requiring only a single I/O pin according to an embodiment of the invention.

FIG. 7 is a logic diagram showing the function of a concurrent I/O pad according to an embodiment of the invention.

FIG. 8 is a logic diagram of components and control signals used for a compaction test according to an embodiment of the invention.

FIG. 9 is the same as the diagram of FIG. 6, but with reseed logic added according to an embodiment of the invention.

FIG. 10 is the same as the diagram of FIG. 3, but with reseed logic and compactor logic added according to an embodiment of the invention.

FIG. 11 is a block diagram of compaction and reseeding circuit according to an embodiment of the invention.

### DETAILED DESCRIPTION

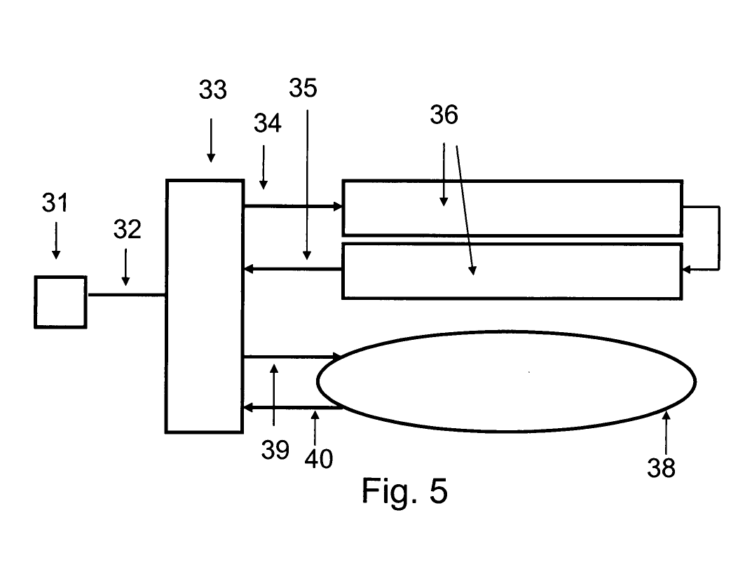

Referring to FIG. 5, a block diagram of a scan-path technique, according to an embodiment of the invention, is shown. The scan path 36 is shown interfacing to a functional circuit of the DUT 38. The scan path 36 uses a single I/O pin 31. Effectively, each I/O pin 31 is configured to be both an input and an output. During a scan test, the I/O data 32 is input through the concurrent I/O circuitry 33. The scan input data 34 is output from the concurrent I/O circuitry 33 and input to the scan path 36. After being processed by the scan path 36 the scan output data 35 is output through the concurrent I/O circuitry 33 to the I/O pin 31 now used for output. Similarly during a functional test, the I/O data 32 is again input through the concurrent I/O circuitry 33. The functional input data 39 is output from the concurrent I/O circuitry 33 and input to the functional circuit of the DUT 38. After being processed by the functional circuit of the DUT 38 the functional output data 40 is output through the concurrent I/O circuitry 33 to the I/O pin 31 now used for functional output. In one embodiment during both the scan and functional tests, during a first clock cycle the pin 31 is configured as an input. After the input shift event, a control signal switches the pin 31 to output. During each subsequent clock cycle, pin 31 is configured first as an input and then as an output.

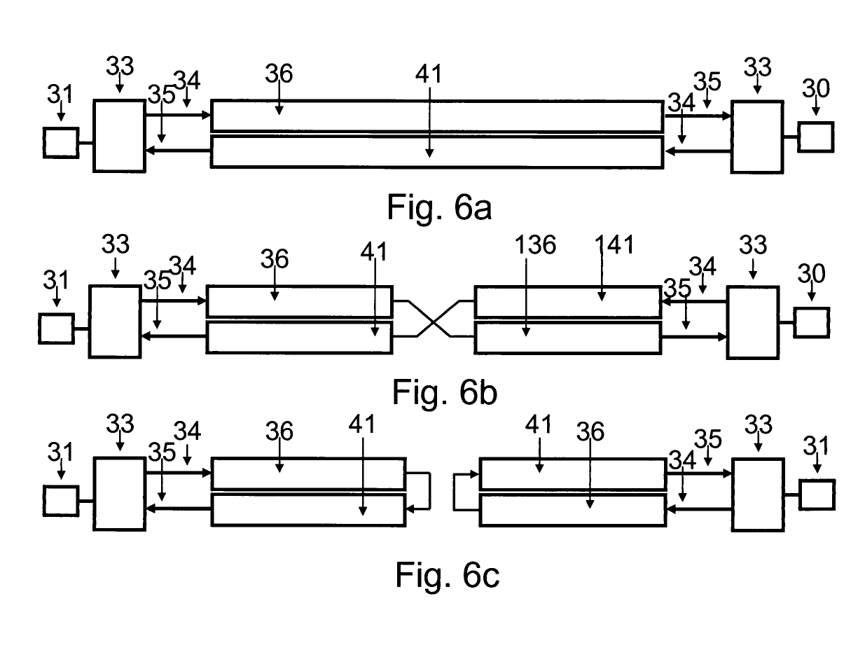

Referring to FIGS. 6a-6c, a single I/O pin can be used as the input for one scan path and output for a different scan path or several scan paths according to an embodiment of the invention such that there is at least one scan path per I/O pin.

Therefore, in FIG. 6a, according to an embodiment of the invention, during a first clock cycle, the top scan path 36 uses I/O pin 31 as an input and the bottom scan path uses I/O pin 30 as an input. During a second portion of the first clock cycle after the shift event, the top scan path 36 uses I/O pin 30 as an output, and the bottom scan path 41 uses I/O pin 31 as an output.

Referring to FIG. 6b, the same basic scheme occurs except that multiple scan paths 36 and 136 can be coupled in series as shown. In this embodiment, during a first clock cycle, pin 31 is input for scan path 36. Scan path 36 provides input to scan path 136, and during a second portion of the first clock cycle after the shift event, pin 30 provides output for the series made up of scan paths 36 and 136. Also, during the first clock cycle, pin 30 is input for scan path 141. Scan path 141 provides input to scan path 41, and during a second portion of the first clock cycle after the shift event, pin 31 provides output for the series made up of scan paths 141 and 41.

Referring to FIG. 6c, according to an embodiment of the invention, multiple scan paths 36 and 41 in series use the same I/O pin 31 as both an input pin during a first clock cycle, and an output pin during a second portion of the first clock cycle after the shift event.

Still referring to FIGS. 6a-6c, on a single DUT there can be multiple scan path implementations such as those shown. Allowing this variety increases the efficient use of routing resources of the DUT since the designer has the flexibility to design the scan paths in any manner that effectively allows at least one scan path per pin.

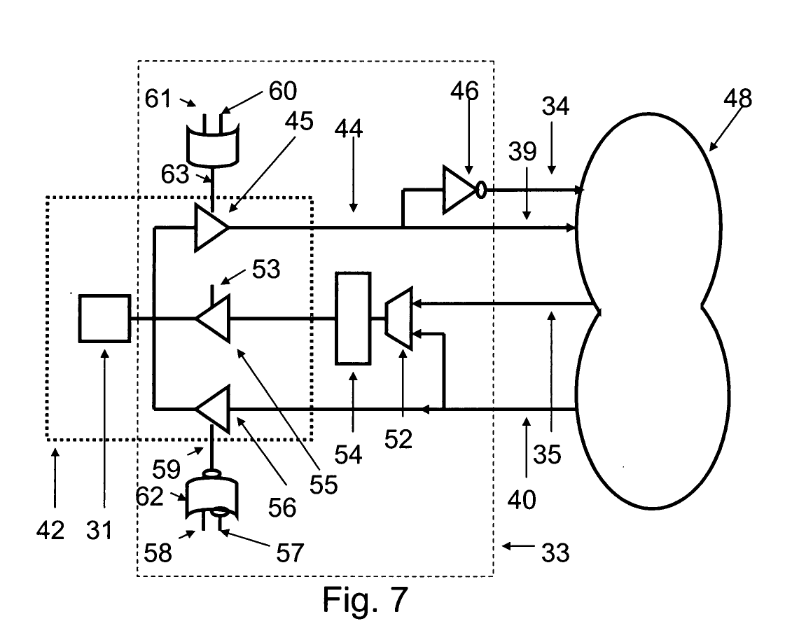

Referring to FIG. 7, a schematic of the input/output circuitry 33 for each pin 31 is shown, according to an embodiment of the invention. During a scan test, the pin 31 can act as an input pin and provide data via the input buffer 45 and a scan-data input buffer 46. During functional operation, the pad 42 is connected to the functional circuit of the DUT 48 directly through the input buffer 45.

Still referring to FIG. 7, the pin 31 can also act as a scan output pin, where the scan output data 40 is multiplexed by a multiplexer 52 into a virtual pin (VP) flip-flop 54, which stores the scan data for shifting out to the pin 31. Effectively, during scan tests, the pin 31 is time division multiplexed. That is, for example, on a first clock cycle scan data is shifted in via the input buffer 45 and the scan data input inverter 46. During this same clock cycle, scan output data 40 is latched into the VP flip-flop 54. Then, during a second portion of the same clock cycle after the shift event, the input buffer 45 is disabled by the input buffer control signal 63 and the VP output buffer 55 is enabled by the VP enable control signal 53, and the scan output data 40 stored in the VP flip-flop 54 is shifted to the pin 31 for reading. Then this cycle can repeat itself. Other variations of this are possible. The input buffer 45 is controlled by the input buffer control signal 63, which is a logical OR of an input enable control signal 60 and a scan/functional control signal 61 used to choose scan test mode or functional mode.

Referring again to FIG. 7, during functional mode, the I/O pin 31 can be configured permanently as an input data pin or an output data pin by appropriately disabling or enabling the input buffer 45 or the output buffer 56 with the input enable signal 60 and the output enable signal 57, respectively. The output buffer 56 is controlled by the output buffer control signal 59, which is output from NOR gate 62 that receives a concurrent I/O control signal 58 and an inverted output enable control signal 57.

Since the VP flip-flop 54 is already present, an option during functional operation is to allow the VP flip-flop 54 to be used to register the output from the functional circuit 48. That is, the VP flip-flop 54 can temporarily store functional output data 40 by appropriate configuration of the multiplexer 52.

Still referring to FIG. 7, in one embodiment of the invention, a program configures the I/O pins 31 as input pins and then as output pins on second portions of the clock cycles after the input shift events. This can be done to all pins so that all pins are input and then output, or alternately only to some pins depending upon the design of the circuit. In the case where all pins are input and then all pins are output, the tester sends an input enable signal 60 and then an output enable signal 57 that will alternately enable the input buffer 45 and then the output buffer 56.

Still referring to FIG. 7, in another embodiment of the invention, the output from the VP flip-flops 54 for multiple I/O pins 31 are serially connected together to form a cyclic shift register to perform compaction. In this case, all of the pins 31 remain input pins to shift in scan input data 34. Simultaneously, the scan output data 35 is shifted into one or more of these cyclic shift registers and processed as discussed in the background section. When all the scan input data 34 has been shifted in and all the results have been shifted out into the cyclic shift register made up of the serially connected VP flip-flops 54, then the contents of the cyclic shift register, where each bit is coupled to its own pin 31, is read out in parallel from the DUT again via the pins 31. Therefore, an advantage of this invention is that the cyclic shift register doesn't need to be a separate dedicated register, but can be formed from the VP flip-flops 54 that are already present to allow one or more scan paths per I/O pin 31.

Another benefit is that this one-scan-path-per-pin scheme can remove the multiplexer 52 from the path between the I/O pin 31 and the output of the functional circuit of the DUT 48, and thus can remove the delay introduced by the multiplexer 52 when the functional circuit output 40 is coupled directly to the output buffer 56.

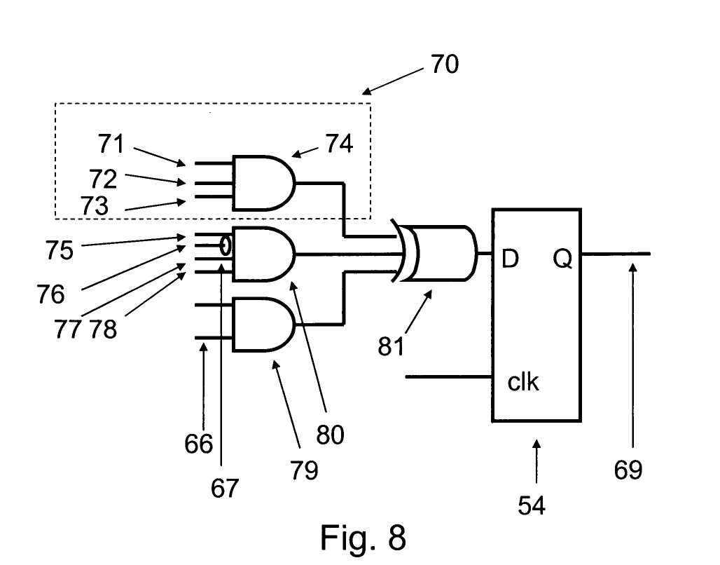

Referring to FIG. 8, a logic diagram of a circuit to control the flip-flop 54 of FIG. 7 is shown according to an embodiment of the invention. The circuit allows the VP flip-flop 54 to be used for compaction by shifting the scan output data 71 or the functional output data 77 directly into the VP flip-flop. Changing the value of the compact signal 67, one can mask the output data 66 for a given clock cycle before it is input to the VP flip-flop 68.

Still referring to FIG. 8, the control signals 70 are for scan output 71, select scan 72 and sample output control 73. These controls are input to an AND gate 74 and provide control input based on tester settings to an OR gate 81 that then gates the VP flip-flop 54. The AND gate 80 provides an output signal to the OR gate 81 and then an input to the VP flip-flop 54 when not in compact mode. AND gate 80 has four input signals, output enable 75, not-scan 76, output data 77, and sample output control 73.

Referring again to FIG. 7, although compaction is not generally used during functional tests because of the higher clock rate, one can use the VP flip-flop 54 for compaction of functional data. For example the functional output data 40 to be output on the output pin 31 can be multiplexed 52 into the VP flip-flop 54 which can be serially coupled to other VP flip-flops to form a register to compact the functional output data 40. However, if functional data compaction is not desired, then the output from the system circuitry can be directly connected to the pin 31.

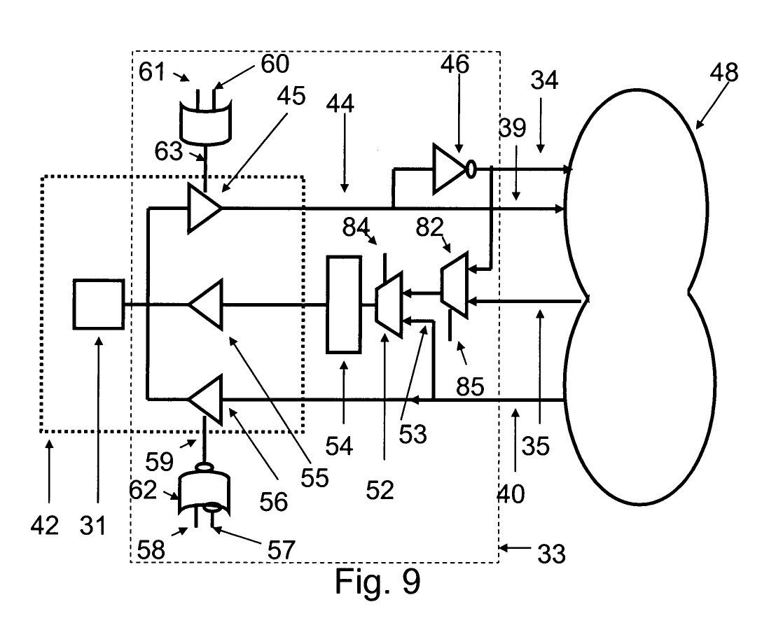

Referring to FIG. 9, the input/output circuitry of FIG. 6 can be modified to perform a reseed built-in self-test according to an embodiment of the invention. Specifically, a reseed structure is added. The scan input data 34 branches as reseed scan input data to a reseed multiplexer 82 where it is multiplexed with the scan output data 35 as controlled by the reseed enable control 85. Here the reseed scan input data 83 is shifted around again when reseed enable control 85 is set for repeated input into the system. More complex logic can be added prior to the reseed multiplexer 82 to provide a more complex reseed function. Furthermore, by utilizing the multiplexer 52 closest to the VP flip-flop 54, one can implement the built-in self-test and also implement concurrent I/O (using the same pin 31 as both an input and an output). By time division multiplexing, this is implemented using the reseed multiplexer 82 where either the scan out data 35 or the recycled reseed scan input data 34 is input to the VP flip-flop 54. At this point, the I/O pin 31 can be configured always as an output if the input data is all generated internally via the reseed multiplexer 82. However, it can still be switched back and forth between input and output as required as long as, during a reseed, the output of the VP flip-flop 54 can get through to the input buffer 45 to the scan input inverter 46.

The circuit of FIG. 9, however, cannot perform compaction and reseeding simultaneously. This is because the VP flip-flop 54 is either used for compaction or for reseeding. It typically cannot be used for both at the same time. When the VP flip-flop 54 is functionally shared between generating patterns and compacting test responses scan test time doubles.

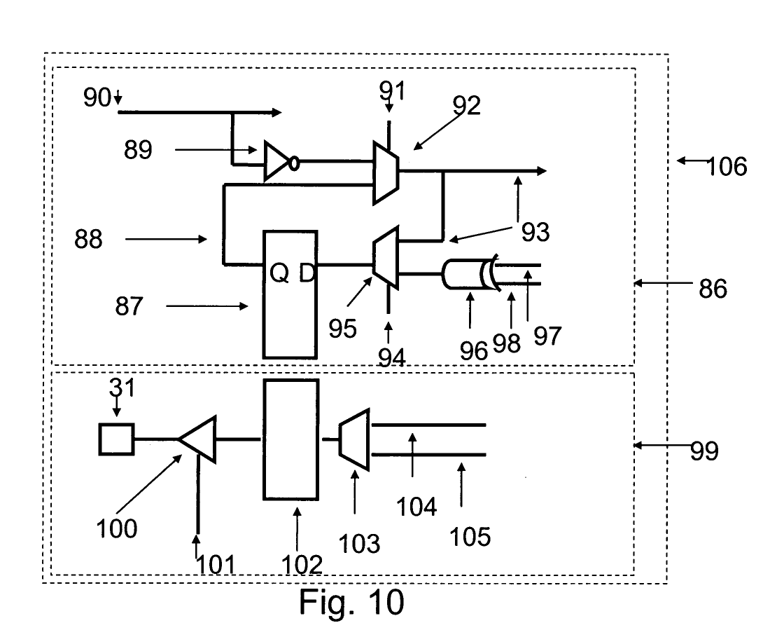

Therefore, referring to FIG. 10, an embodiment of input/output circuitry 106 that uses two flip-flops is shown, according to an embodiment of the invention. The reseed flip-flop 87 and associated reseed circuitry 86 is used for the reseed built in self-test function, while the compaction flip-flop 102 and associated compaction circuitry 99 is used for compaction. As shown, the reseed flip-flop 87 need not be coupled to the I/O pin 31, and can therefore be connected to the scan input 93 via multiplexer 92. The reseed circuitry 86 is similar to that described in FIG. 9 above. The input signal 90 is inverted 89 and multiplexed 92 with the reseed flip-flop output 88. The multiplexer 92 is controlled by the LFSR enable control signal 91. A reseed multiplexer 95 is controlled by a reseed enable control signal 94 and multiplexes the scan input data 93 with the output of an or-gate 96, which has inputs LFSR-input 97 and LFSR-feedback 98.

Referring to the bottom half of FIG. 10, the associated compaction circuitry 99 with the compaction flip-flop 102 also includes a multiplexer 103 for multiplexing the scan output data 104 and functional output data 105 and feeding them through the compaction flip-flop 102 to VP output buffer 100 enabled by the VP enable control signal 101 and then to the I/O pin 31.

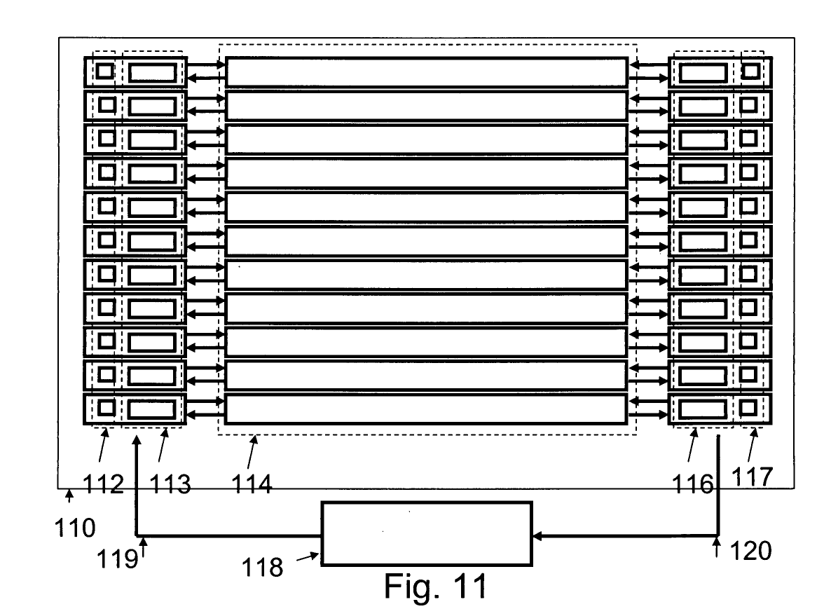

Referring to FIG. 11, a DUT 110 is being tested by a test unit 118 in an embodiment of the invention doing reseeding and compaction as part of the same operation. At a first time, the DUT 110 loads a seed 119 via a first set of I/O pins 112 used for input to a first set of VP flip-flops 113 used as a LFSR. The seed is decompressed and the set of scan paths 114 accepts these inputs over a number of clock cycles and produces outputs stored in a second set of VP flip-flops 116 with a second set of I/O pins 117 used as a compactor register that compacts the outputs over the same number of clock cycles. At a second time the compacted response 120 is read into the test unit 118 and analyzed.

Referring again to FIG. 11, in another embodiment of the invention, once the data is compacted, instead of outputting the data in parallel from the second set of VP flip-flops 116 in the second set of I/O pads 115 used as a compactor register, the data can be serially shifted out by serially connecting all of the second set of VP flip-flops 116 together such that all the data comes out of a single I/O pin. This may be desirable during a multi-site test where multiple devices are tested simultaneously. Here, the tester may not have enough pins to receive all the outputs, so it disables all but one of the outputs and uses the single serial output to get all the data. In fact, the serial chain can extend through the multiple devices such that the input to the chain is to one device and the output is from another device. Here, the serial data is test data in and test data out. In this way, for a multi-site test, virtually all of the data pins that are connected to the tester can be used as input pins and there is one single output I/O pin.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. An integrated circuit comprising:
a plurality of pins; and
at least one scan path per pin.

2. The integrated circuit of claim 1 wherein:
a first I/O pin is operable to input scan test data at a first test time; and
the first I/O pin is operable to output scan test data at a second test time.

3. The integrated circuit of claim 2 wherein:
the first I/O pin is operable to input scan test data to a first scan path at the first test time;
a second I/O pin is operable to input scan test data to a second scan path at the first test time;
the first I/O pin is operable to output scan test data from the second scan path at the second test time; and
the second I/O pin is operable to output scan test data from the first scan path at the second test time.

4. The integrated circuit of claim 3 wherein the first scan path further comprises a series of scan paths.

5. The integrated circuit of claim 2 further comprising a series of scan paths wherein:
the first I/O pin is operable to input scan test data to the series at a first test time; and
the first I/O pin is operable to output scan test data from the series at a second test time.

6. The integrated circuit of claim 2 further comprising functional circuitry wherein:
the scan path interacts with the functional circuitry; and
the I/O pin is operable to input scan test data at the first test time; and
the I/O pin is operable to output scan test data at the second test time.

7. The integrated circuit of claim 2 further comprising functional circuitry wherein:
the I/O pin is operable to input functional test data at the first test time; and
the I/O pin is operable to output functional test data at a the second test time.

8. An integrated circuit comprising:
a first I/O pin operable to receive input data during a test time; and
a second I/O pin operable to provide output data during the test time.

9. The integrated circuit of claim 8 further comprising a first scan path wherein:
the first I/O pin is operable to input scan test data during the test time; and
the second I/O pin is operable to output scan test data during the test time.

10. The integrated circuit of claim 9 further comprising a second scan path wherein:
the first I/O pin is operable to input scan test data to the first scan path during the test time;
the output from the first scan path is input to the second scan path; and
the second I/O pin is operable to output scan test from the second scan path data during the test time.

11. The integrated circuit of claim 9 further comprising any number of scan paths and the same number of I/O pins wherein:
each I/O pin is operable to input scan test data during the test time;
each I/O pin is operable to input scan test data during the test time; and
a tester determines the function of each I/O pin during the test time.

12. An integrated circuit comprising;
a functional circuit operable to produce functional output;
a scan path operable to produce scan output;
an I/O pin operable to be used as input at a first time and as output at a second time; and
a flip-flop coupled to the I/O pin and to the functional circuit and the scan path operable to hold the functional output or the scan output for a clock cycle.

13. The integrated circuit of claim 12 further comprising:
a number of scan paths;
the same number of I/O pads; and
the same number of flip-flops operable to form at least one register.

14. The integrated circuit of claim 13 wherein
each I/O pad further comprises a scan output buffer;
each flip-flop further comprises;
a compact-control signal;
an output-data signal; and
an and-gate operable to eliminate don't-care data; and
the register is operable as a compaction register.

15. The integrated circuit of claim 13 wherein:
each I/O pad further comprises;
a reseed multiplexer operable to receive functional output data and scan input data;
a reseed control signal operable to control the reseed multiplexer; and
the register is operable as a reseed register.

16. The integrated circuit of claim 15 wherein:
each I/O pad further comprises an or-gate operable to receive input from the output of a linear feedback shift register; and
the register is operable as a linear feedback shift register.

17. The integrated circuit of claim 13 further comprising a second number of flip-flops operable to form a compaction register wherein:
the integrated circuit is operable to perform reseeding; and
the integrated circuit is at the same time operable to perform compaction.

18. The integrated circuit of claim 17 wherein the compaction register can be read serially.

19. A method comprising:
inputting scan data to an I/O pin during a first time;
processing the scan data in a scan path to produce scan output data; and
outputting the scan output data to the I/O pin at a second time.

20. The method of claim 19 further comprising:
multiplexing output data and scan output data; and
storing the output data or scan output data in a flip-flop during the first time.

21. The method of claim 20 further comprising:
connecting a number of flip-flops associated with I/O pins; and
forming a register performing a reseed test.

22. The method of claim 21 wherein forming a register further comprises:
sending a compact control signal;
and-gating the compact control signal with the output data;
eliminating don't care data; and
performing compaction.

23. The method of claim 21 wherein forming a register further comprises:
sending a reseed control signal to a reseed multiplexer;
multiplexing functional output data and scan input data; and
performing a reseed test.

24. The method of claim 23 wherein multiplexing further comprises:
receiving gated input from a linear feedback shift register; and
performing a linear feedback shift register reseed test.

25. The method of claim 19 wherein the first time and the second time occur during the same clock cycle.
